(19) United States
(12) Patent Application Publication
(10) Pub. No.: US 2024/0070738 A1
(43) Pub. Date: Feb. 29, 2024

(54) GOODS AND SERVICES MARKETPLACE AND METHOD THEREOF

(71) Applicant: Bryan Chavez, Pickering (CA)

(72) Inventor: Bryan Chavez, Pickering (CA)

(21) Appl. No.: 17/823,092

(22) Filed: Aug. 30, 2022

(51) Int. Cl. G06Q 30/06; G06Q 10/08

(52) U.S. Cl. CPC G06Q 30/0611; G06Q 10/0833; G06Q 30/0619; G06Q 30/0637

(57) ABSTRACT

A method of goods and services attainment method that is executed via a software application wherein the present invention facilitates a buying and selling of goods with additionally providing the ability to actively negotiate on an item for sale. The present invention includes a plurality of buyers and sellers utilizing a software application loaded onto computing devices wherein the software application provides an electronic marketplace. Enrolled members are offered various types of memberships with benefits while non-members are able to utilize the electronic marketplace. A featured step in the present invention is the ability to broker an active negotiation between the seller and buyer of an item. The present invention further includes a mobile container that is configured to facilitate delivery of the item subsequent the purchase thereof. Multiple embodiments of the mobile container are within the scope of the present invention.

### FIELD OF THE INVENTION

The present invention relates generally to business methods facilitated by software, more specifically but not by way of limitation, a business method operable to enable buying, selling and trading of good and services wherein the process of the present invention further includes an active negotiation phase.

### BACKGROUND

Electronic commerce is now a normal technique to buy and sell goods and services. Only a few decades ago, electronic commerce was an aspirational objective for retailers of all sizes. Presently, electronic commerce corporations sell billions of dollars worth of goods and services every year. Conventional retailers also have electronic commerce branches that enhance their ability to reach potential customers and increase sales. Electronic commerce is provided in many channels such as but not limited to direct retailers as well as electronic marketplaces that are similar to conventional classified ads. These electronic marketplaces provide an opportunity for individuals and businesses to sell, buy and trade goods.

One issue with conventional electronic marketplaces that facilitate the buying and selling of goods is the inability for the software to broker and active negotiation between the buyer and seller. While many electronic marketplaces allow a fixed purchased price and enable the buying of an item through the electronic marketplace, these electronic marketplaces do not facilitate the ability to negotiate a price of an item. While some electronic marketplaces facilitate bidding on an item, this provides a buyer only the opportunity to bid on an item against other buyers and does not provide an opportunity to directly negotiate with the seller. Furthermore, the delivery of the purchased item is often executed through shipping or other similar channel wherein this adds cost to the item. If an individual is the seller, the item may be arranged to be picked up at a physical location which can be a geographical inconvenience or prevent a potential security risk to the buyer.

It is intended within the scope of the present invention to provide an electronic marketplace that facilitates the selling and buying of goods wherein the present invention enables active negotiation during the buying process. Furthermore, the present invention provides a plurality of mobile containers that are utilized to facilitate the delivery of the good to the buyer.

### SUMMARY OF THE INVENTION

It is the object of the present invention to provide an electronic marketplace that is operable to facilitate the selling and buying of goods between two entities wherein the present invention provides a website having a listing of a multitude of goods for sale thereon.

Another object of the present invention is to provide a method of buying a good wherein a negotiation phase is enabled and tracked by the method wherein the software application of the present invention is utilized to provide an active negotiation between the seller and buyer.

A further object of the present invention is to provide an electronic marketplace that is operable to facilitate the selling and buying of goods between two entities wherein a step of the present invention includes enrolling users and offering different membership profiles to the enrolled users.

Still another object of the present invention is to provide a method of buying a good wherein a negotiation phase is enabled and tracked by the method wherein the present invention further includes providing a plurality of mobile containers.

An additional object of the present invention is to provide an electronic marketplace that is operable to facilitate the selling and buying of goods between two entities wherein the plurality of mobile containers are employed to deliver purchased goods.

Yet a further object of the present invention is to provide a method of buying a good wherein a negotiation phase is enabled and tracked by the software application executing the method wherein the present invention further includes the ability to facilitate the trading of one good for another good between two entities.

Another object of the present invention is to provide an electronic marketplace that is operable to facilitate the selling and buying of goods between two entities wherein the mobile container is moved around between various locations during a certain time period.

An alternate object of the present invention is to provide a method of buying a good wherein a negotiation phase is enabled and tracked by the software application executing the method wherein the method includes the ability to execute and rejection of an offer from a buyer multiple times by the seller.

An alternative objective of the present invention is to provide an electronic marketplace that is operable to facilitate the selling and buying of goods between two entities wherein the software application provides tracking of the complete negotiation process between the seller and the buyer.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a is a flowchart of an exemplary method of the present invention; and

FIG. 2 is a diagrammatic view of the components of the present invention

### DETAILED DESCRIPTION

References now to the drawings submitted herewith, wherein various elements depicted therein are not necessarily drawn to scale and wherein through the views and figures like elements are referenced with identical reference numerals, there is illustrated a goods and services attainment method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

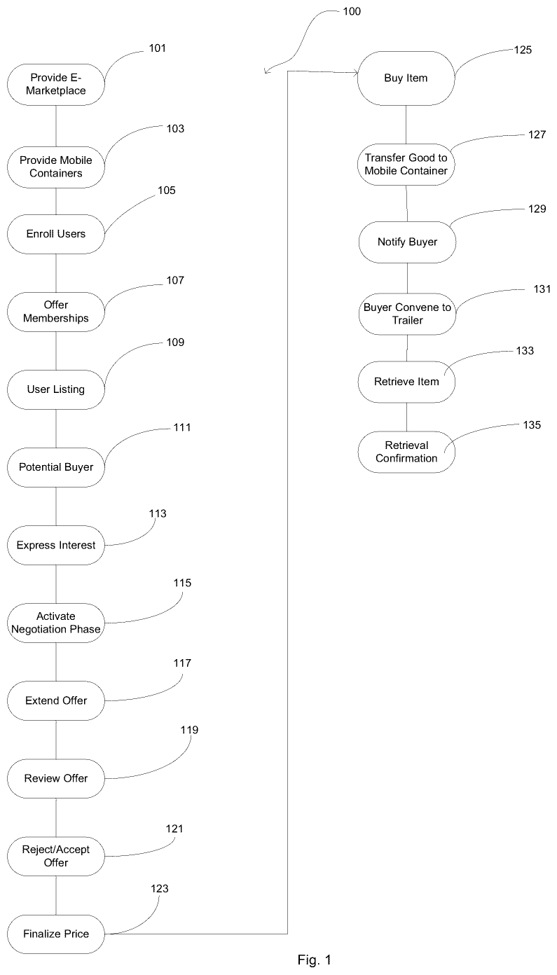

Now referring to the Drawings submitted as a part hereof, the method of goods and services attainment method 100 is diagrammed in FIG. 1 submitted herewith. The method of the present invention is facilitated by a software application wherein the software application is operated on mobile and desktop computing devices. In step 101, the software application of the present invention provides an electronic commerce marketplace whereupon items are listed for sale by sellers. It should be understood within the scope of the present invention that the electronic commerce marketplace can contain various data about the items for sale such as but not limited to a photograph, specifications and price. It is contemplated within the scope of the present invention that the electronic commerce marketplace could be divided into a plurality of categories so as to segment the items for purposes of searching by potential buyers. In step 103, the operator of the goods and services attainment method 100 will provide and control the operation of a plurality of mobile containers. The mobile containers of the present invention in a preferred embodiment are contemplated to be cargo trucks with staffed drivers but it should be understood within the scope of the present invention that alternate types of containers could be employed as will be further discussed herein.

In step 105, the operator of the present invention will enroll users into the goods and services attainment method 100. Enrollment of users can be executed through various different methods such as but not limited to electronic solicitation. Step 107, ensuing enrollment of members, the operator of the goods and services attainment method 100 will offer alternate membership packages to the enrolled users. It should be understood within the scope of the present invention that the membership packages could include but are not limited to free delivery of goods, secure meeting locations and an ability to disable advertisement views on the software application when engaged in the user thereof. In step 109, a user will list a good for sale. Ensuing a good being listed, the good is available for viewing to all users of the present invention. Step 111, a potential buyer will view a listed good for sale. Step 113, the potential buyer will express an interest in purchasing the listed good. In step 115, the potential buyer will engage a provided icon that starts an active negotiation process between the potential buyer and the seller of the listed good. It should be understood within the scope of the present invention that the potential buyer can agree to buy the listed good at the published price and not engage in a negotiation phase.

In step 117, the potential buyer will enter an initial offer into the software application for the listed good that the potential buyer desires to purchase. Step 119, the seller of the good will receive notification from the software application that a buyer has tendered an initial offer for the good listed by the seller. The seller will review the offer tendered by the potential buyer. In step 121, the seller will decide to accept or reject the initial tendered offer for the good. An acceptance or rejection notification is then electronically transmitted to the potential buyer. If the initial tender is accepted then the process proceeds to step 123. If the initial tender is rejected then the process will repeat from step 117 to step 121 until the offer from the potential buyer is accepted. It should be recognized that if an offer is not accepted by the seller then the process is terminated. In step 123, the seller and the potential buyer agree upon a finalized price which is captured in the software application of the present invention.

Step 125, the buyer will purchase the good at the agreed upon price wherein the funds for the purchase are routed through the software application of the present invention. In step 127, the good is transferred to a mobile container for delivery of the good. It is contemplated within the scope of the present invention that the good can be transferred to the mobile container utilizing a plurality of alternate methods. Furthermore, it should be understood within the scope of the present invention that delivery of the purchased good could occur on occasion through conventional known delivery methods. Step 129, ensuing the transfer of the good to the mobile container, the software application of the present invention transmits an electronic notification to the buyer that the good is available for pickup. In step 131, the buyer is notified of the location of the mobile container and can convene to the identified location. It should be further understood within the scope of the present invention that the mobile container could be arranged to traverse to the location of the buyer.

Step 133, subsequent convening with the mobile container the buyer will retrieve the purchased item therefrom. It should be understood within the scope of the present invention that the mobile container could be provide either with or without an operator. If an operator is present, the operator will assist in retrieving the item from the mobile container. If the mobile container does not have an operator, it is contemplated within the scope of the present invention that the mobile container could employ remotely operated locks utilizing QR codes or other suitable technology. In step 135, subsequent retrieval of the item from the mobile container the software application of the present invention will transmit an electronic notification of retrieval of the item to the buyer and the seller.

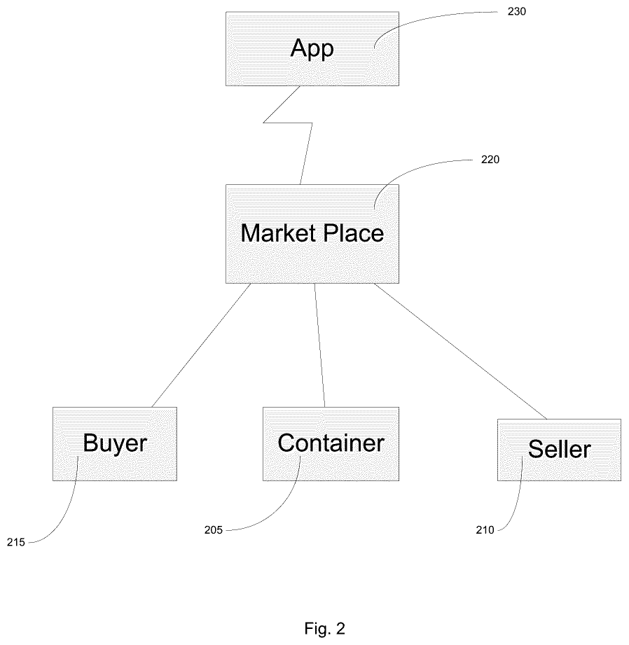

Referring now to FIG. 2 submitted as a part hereof, a schematic of the core elements of the method of goods and services attainment method 100 is diagrammed therein. The electronic marketplace 220 is operated by the software application 230 of the present invention. It should be understood within the scope of the present invention that the electronic marketplace 220 is hosted on a conventional computer server with the software application 230 providing a graphical interface for utilization thereof. The buyer 215 and seller 210 interact with the method of goods and services attainment method 100 via computing devices such as but not limited to mobile computing devices that have the software application loaded thereon. The mobile container 205 is employed to execute delivery of a good once a good has been purchased via the present invention. It should be understood within the scope of the present invention that numerous embodiments of the mobile container 205 are contemplated. By way of example but not limitation, the mobile container 205 could be an attended cargo truck, a transportable container, unattended lockbox or numerous other embodiments that are suitable to facilitate the receipt, storage and retrieval of items.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A method configured to facilitate buying and selling of items between a plurality of buyers and sellers wherein the method comprises the steps of:
providing a software application, said software application being stored on a computing device wherein the computing device is accessible via conventional communication protocols;
downloading the software application, wherein the buyers and sellers download the software application onto a remote computing device;
registering with the software application, wherein the buyers and sellers will complete the registration process of the software application;
listing a plurality of items for sale, wherein the sellers will list a plurality of items for sale on an electronic marketplace established via the software application;
reviewing the plurality of items for sale, wherein at least one of the buyers enters the electronic marketplace and reviews items for sale;
expressing an intent to purchase at least one of the plurality of items;
activating a negotiation platform, wherein the buyer will initiate an offer via the software platform for a selected item;
transmitting a notification, wherein the software application will transmit a notice to the seller with information on the offer from the buyer;
reviewing the offer from the buyer, wherein the seller will review the offer for the item from the buyer;
deciding to accept or reject the offer, wherein the seller will decide whether or not to accept the offer;
rejecting the offer from the buyer, wherein the seller rejects the offer from the buyer;
transmitting a counteroffer, wherein subsequent rejection of the offer the seller transmits a counteroffer to the buyer via the software application of the present invention;
reviewing the counteroffer, wherein the buyer reviews the counteroffer from the seller;
accepting the counteroffer, wherein the buyer accepts the counteroffer from the seller and wherein acceptance of the counteroffer is transmitted to the seller;
arranging payment collection for the item, wherein the software application will facilitate an exchange of currency between the buyer and the seller;
delivering the item to the buyer, wherein a mobile container is employed to provide delivery of the item to the buyer.

2. The method configured to facilitate buying and selling of items between a plurality of buyers and sellers as recited in claim 1, and further including the step of offering memberships to the buyers and sellers, wherein the memberships include alternate levels and benefits to the buyers and sellers.

3. The method configured to facilitate buying and selling of items between a plurality of buyers and sellers as recited in claim 2, wherein the mobile container is transported to a location geographically proximate the buyer.

4. The method configured to facilitate buying and selling of items between a plurality of buyers and sellers as recited in claim 3, and further including the step of convening to the mobile container to retrieve the item, wherein the buyer proceeds to the mobile container to retrieve the item.

5. The method configured to facilitate buying and selling of items between a plurality of buyers and sellers as recited in claim 4, and further including the step of transmitting a notification to the seller, wherein upon retrieval of the item from the mobile container the software application will transmit a notice to the seller confirming retrieval of the item.

6. The method configured to facilitate buying and selling of items between a plurality of buyers and sellers as recited in claim 1, and further including the step of avoiding the negotiation platform, wherein the buyer can directly purchase the item from the seller at a listed price.

7. The method configured to facilitate buying and selling of items between a plurality of buyers and sellers as recited in claim 5, wherein the mobile container is a transportable and lockable storage container.

8. The method configured to facilitate buying and selling of items between a plurality of buyers and sellers as recited in claim 5, wherein the mobile container is embodied as a cargo truck.
